(19) United States
(12) Patent Application Publication
(10) Pub. No.: US 2011/0274290 A1
(43) Pub. Date: Nov. 10, 2011

(54) FAST START-UP CIRCUIT FOR AUDIO DRIVER

(75) Inventors: Peter (aka Petrus) J. Holzmann, San Jose, CA (US); Lance Wong, San Francisco, CA (US); Hsi-Fu Tan, Zhubei (TW); Chen-Chou Hsieh, Santa Clara, CA (US)

(73) Assignee: NUVOTON TECHNOLOGY CORPORATION, Hsin-Chu (TW)

(21) Appl. No.: 12/773,555

(22) Filed: May 4, 2010

(51) Int. Cl. H04B 15/00; G05F 3/02

(52) U.S. Cl. 381/94.1; 327/538

(57) ABSTRACT

A driver device for suppression audible transients of an audio amplifier includes an amplifier for receiving an audio signal and a bias circuit configured to quickly generate a voltage level for biasing the amplifier, wherein the voltage level is maintained even if the driver device is powered off. The bias circuit may include a CMOS inverter having a negative feedback that has a standby current of less than 100 nA. The bias circuit further includes a buffer for rapidly charging an external capacitor. The buffer may change to a high impedance state rapidly when the power supply is disconnected.

### BACKGROUND OF THE INVENTION

Embodiments of the present invention relates generally to electronic circuit techniques. More specifically, embodiments of the present invention provide techniques for suppressing transients in amplifier circuits. Merely by way of example, some embodiments of the invention have been applied to audio power amplifiers for suppressing power up transients (e.g., popping noises) while also providing fast startup when the power amplifiers are turned on. But it would be recognized that the invention has a much broader range of applicability.

Amplifier circuits are prevalent in modern electronic devices. For example, an audio amplifier is an electronic amplifier that amplifies low-power audio signals to a level suitable for driving sound producing devices, such as loudspeakers or headphones. When audio power amplifiers use a single power supply, their output is usually biased at the mid-point of the power supply voltage. A large AC coupling capacitor may be connected between the output of the amplifier and a loudspeaker. The capacitor is used to block any DC current from flowing through a loudspeaker that has low impedance.

FIG. 1 shows a conventional audio amplifier 100 for driving a speaker 140. Audio amplifier 100 includes an input amplifier A1 110 having a negative input coupled to an audio signal Vin 101 via a RC network and a positive input coupled to a bias voltage VMID 111. The RC network includes a capacitor C1 102 and a resistor R1 103 that together form a low-pass filter. A voltage divider formed by resistors R3 113 and R4 114 generates the bias voltage VMID 111 that serves as a common mode voltage for amplifiers 110 and 130. Amplifier A2 120 is a unity gain amplifier that serves as a buffer for an output signal 118. The nodes of all these components are originally at zero potential when the audio amplifier is in a power-off state.

Even though conventional audio amplifiers are widely used, they suffer from many limitations. One of the limitations is pop noise or click noise that can be produced in transient states of the amplifier. For example, a pop noises can often be heard during power-on of an audio amplifier. Conventional circuit techniques are expensive and often ineffective.

Therefore, new circuits and methods are needed that eliminate pops and clicks without significantly impacting the performances of audio amplifiers.

### BRIEF SUMMARY OF THE INVENTION

When an amplifier is powered on, its internal nodes can be charged at different speeds causing transient currents to flow in an uncontrollable manner and may also result in a long settling time before the amplifier is ready. Transient currents may flow through the AC coupling capacitor to the loudspeaker, which generates pop or click sound. In the following description, the term “pop” will be used for unwanted sound generated at power up and power down of an audio amplifier.

In an embodiment, a driver device for suppressing audible transients of an audio amplifier includes an amplifier for receiving an audio signal and a bias circuit configured to generate a stable voltage level for biasing the amplifier, wherein the voltage level is maintained even if the driver device is in an idle state or is powered off. In an embodiment, the bias circuit includes a CMOS circuit having minimum-geometry transistors such that the bias current is kept low when the bias voltage level is about half the supply voltage. In a specific embodiment, the bias circuit includes a CMOS inverter with an output tied to its input for providing a bias level near the mid point of the voltage supply range. In an embodiment, a buffer circuit is coupled between the bias circuit and a capacitor. The buffer circuit is configured to charge up the capacitor to the bias level quickly when the device is turned on, and, when the power is turned off, the buffer circuit is in a high impedance state to prevent leakage from the capacitor. In an embodiment, the buffer circuit is configured to maintain the capacitor voltage at around the mid point of the voltage supply. In a specific embodiment, the buffer circuit is implemented as a CMOS source follower with a transistor having substantially zero threshold voltage.

In another embodiment, a voltage reference circuit includes a bias circuit for generating a reference voltage. The voltage reference circuit further includes a capacitor coupled to the bias circuit for storing and maintaining the reference voltage. The voltage reference circuit also includes a buffer circuit for charging the capacitor, wherein the buffer circuit is in a high-impedance state when the circuit is in an idle state or powered off.

In yet another embodiment, a method of suppression audible transients includes generating a reference voltage using a self-biased circuit and charging a capacitor using a buffer circuit, wherein the buffer circuit is in a high impedance state when a power supply source is disconnected or powered off.

The device, circuit, and methods according to the present invention can be applied to conventional audio amplifiers. Parts and functions of the present invention include a native NMOS transistor as output driver for charging an external capacitor. In an embodiment, parts and functions of the present invention include a CMOS inverter having the output electrically coupled to the input for forming a self biased circuit that generates a common-mode voltage substantially independent of the power supply voltage and temperature.

These and other features and advantages of embodiments of the present invention will be more fully understood and appreciated upon consideration of the detailed description of the preferred implementations of the embodiments, in conjunction with the following drawings.

### BRIEF DESCRIPTION OF THE DRAWINGS

FIG. 1 is a block diagram of a conventional audio amplifier;

FIG. 2 is a graph illustrating the voltage waveforms of certain nodes of the conventional audio amplifier of FIG. 1 at power up;

FIG. 3 is a simplified block diagram of a fast start-up audio amplifier according to an embodiment of the present invention;

FIG. 4 is a simplified schematic diagram of a reference voltage circuit according to an embodiment of the present invention;

FIG. 5A is a graph illustrating an idealized voltage transfer characteristic of a CMOS inverter;

FIG. 5B is a graph illustrating typical voltage characteristics of the CMOS inverter at different values of the power supply; and

FIG. 6 is a graph illustrating voltage waveforms at the speaker terminals at power up according to an embodiment of the present invention.

### DETAILED DESCRIPTION OF THE INVENTION

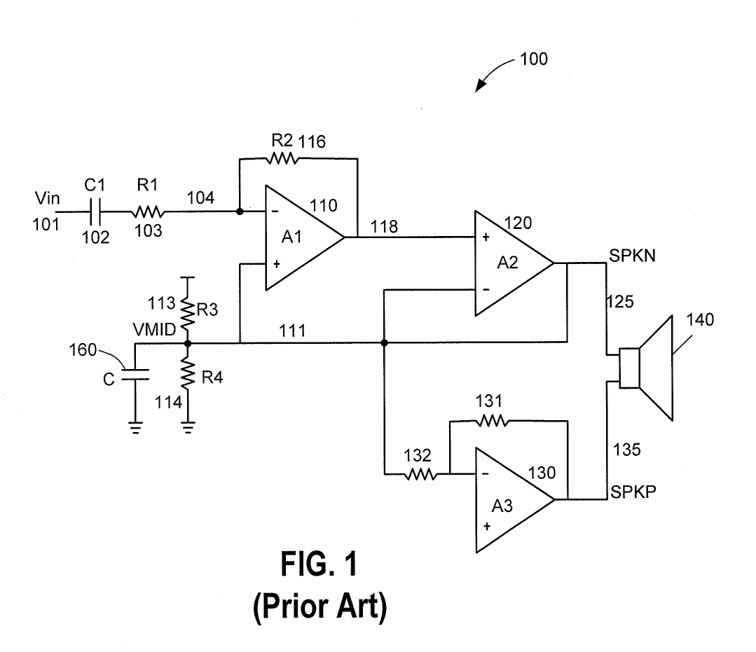

As noted above, conventional amplifier circuits can be susceptible to transient settling and noises. Specifically, in an audio amplifier, power-on transient can create pop noises and long turn-on times which are undesirable. As an example, FIG. 1 shows a block diagram of a conventional audio amplifier 100, which includes amplifiers A1, A2, and A3, and resistors 103, 113, 114, 116, 131 and 132. With reference to FIG. 1, when audio amplifier 100 is powered on, the nodes are not charged to their stable states at the same time, the different charging times at different amplifier stages cause a voltage differential at the speaker terminals SPKN and SPKP, which produce pops and clicks. That is, any time difference in biasing the input amplifier stage, one or more intermediate stages and/or the output amplifier stage will result in pops and clicks as well as impose a delay before audio can be outputted at the speaker.

Audio amplifier 100 also includes a capacitor C 160 for keeping the common mode voltage stable. Capacitor C 160 needs to be large in order to get a high PSRR value (power supply rejection ratio). But a large capacitor will slow down the start-up time of audio amplifier 100 because of the long charging time period until the capacitor is fully charged. One known solution is to have a low initial impedance value for resistor R3 113 for rapidly charging capacitor C 160, then switch to a higher resistive value of R3 113 once capacitor C 160 reaches a predetermined voltage level. That is, the solution uses a two-step approach to charge capacitor 160: a fast charging step and a slow charging step that are controlled by a comparator that compares the charging voltage level with the predetermined voltage level. However, this two-step approach does not fully suppress or eliminate pops and clicks because it does not guarantee that the voltage levels at the positive and negative inputs of amplifier A1 110 will have the same value during the start-up time. For example, voltage signal 104 may arrive later than the built-up of VMID 111 due to the delay in the low-pass filter. Or voltage reference VMID 111 may arrive later than signal 104 due to the large time constant determined by R3 113 and C 160.

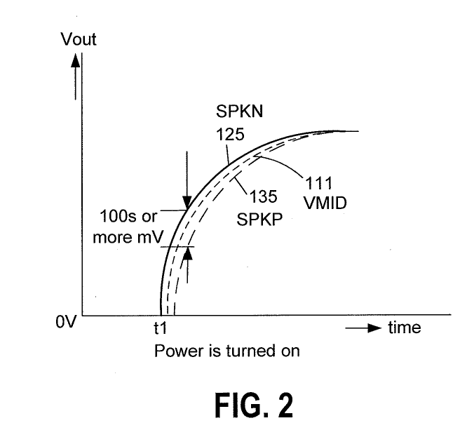

FIG. 2 is a graph illustrating the voltage waveforms of voltage VMID 111 and at the terminals SPKN 125 and SPKP 135 of speaker 140. Before time t1, the power supply of audio amplifier 100 is turned off or disconnected. Bias voltage VMID 111, terminal voltages 125 and 135 of speaker 140 are at a ground potential, i.e., 0 V. At time t1, the power supply Vcc is turned on or electrically connected to audio amplifier 100, an output signal 118 of amplifier A1 110 turns positive first because the voltage at its negative input is lower than that of its positive input due to the delay caused by the RC network. The positive voltage at amplifier A1 110 will appear as waveform 125. The voltage of VMID 111 will rise to a predetermined bias point that is set by the resistor divider. And the voltage 135 at speaker terminal 135 will follow VMID. Thus, the different rising times of voltages at speaker terminals can be several hundreds of milliseconds and the difference between terminals SPKN 125 and SPKP 135 can be several hundreds of millivolts or more. The voltage difference will result in pops and clicks and delay readiness at speaker 140.

Various embodiments of the present invention will be described in detail with reference to the drawings. These diagrams are merely examples, and should not unduly limit the scope of the claims herein. In connection with the various aspects illustrated and described, one of ordinary skill in the art would recognize other variations, modifications, and alternatives.

Throughout the specification and claims, the term “circuit” means at least a single component or multiple components; the terms “bias voltage,” “reference voltage,” “common mode voltage” mean an operating voltage level of the audio amplifier; the term “audio driver” means an “amplifier circuit” for driving a speaker. The term “signal” means at least a current, voltage, or other signal. The term “powered off” means at least that an internal or external power supply to the audio driver is electrically disconnected from the audio driver or turned off.

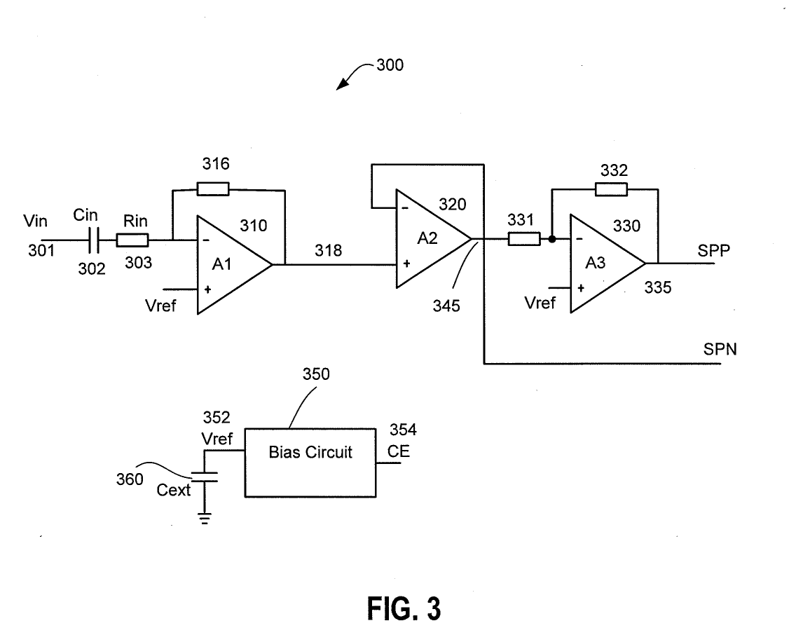

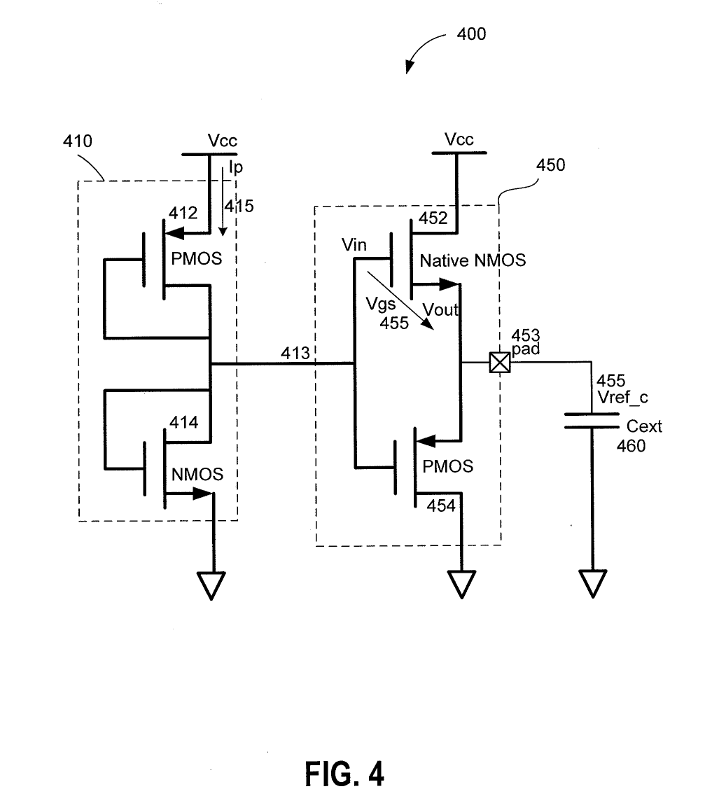

FIG. 3 is a simplified block diagram of a fast start-up audio amplifier 300 according to an embodiment of the present invention. As described above in relation to FIG. 1, pops noises are mainly caused at the input and output stages of an audio amplifier due to the time difference in building up voltage levels at the audio amplifier nodes. And the pops and click can be suppressed with a fast built-up of the bias voltage VMID. In an embodiment, audio amplifier 300 includes an input amplifier 310 (A1), 320 (A2), and 330 (A3), and resistors 316, 331, and 332. As shown, input amplifier 310 receives an input signal Vin 301 via capacitor Cin 302 and resistor Rin 303. Input amplifier 310 provides an amplified output signal 318 to a subsequent amplifier 320 that may operate as a unity gain amplifier. Amplifier 320 provides a first buffered signal 345 that can directly drive one input of a speaker (e.g., SPN). Buffered signal 345 is further coupled to amplifier 330, which provides a second buffered signal 335 that has a phase opposite to that of buffered signal 345. Second buffered signal 335 can drive a second input of the speaker (e.g., SPP). Input amplifier 310 includes an input for receiving a common mode voltage Vref 352 that is generated from a dc bias circuit 350. In an embodiment, dc bias circuit 350 is coupled to an external capacitor Cext 360 for storing and maintaining the reference voltage Vref 352 for a stable operation and for obtaining a high PSRR for audio amplifier 300. In another embodiment, dc bias circuit 350 may include a CE control input 354 for powering up (turning on) and down (turning off) the power supply of audio amplifier 300. Detail of dc bias circuit 350 will be described in more detail below in conjunction with FIG. 4.

FIG. 4 is a simplified schematic diagram of a reference voltage circuit 400 according to an embodiment of the present invention. Reference voltage circuit 400 includes a dc bias circuit 410 and a buffer circuit 450. DC bias circuit 410 includes a P-channel MOS transistor 412 and an N-channel MOS transistor 414. The P-channel and N-channel transistors 412, 414 are connected in series and interposed between a power supply source and a power supply sink. In an embodiment, the power supply sink has a ground potential. In an embodiment, P-channel and N-channel transistors 412, 414 can be implemented as a CMOS inverter with a negative feedback, i.e., with its output electrically coupled to its input. The negative feedback around the complementary pair of transistors will cause the pair to self bias itself to a voltage level between the power supply source and the power supply sink. Due to the symmetry of the P- and N-channels transistors of the CMOS inverter, the negative feedback may set the output of the inverter to approximately a mid-point of the supply voltage.

In an embodiment, the relative output level of the inverter needs to be made to approximate one half of the voltage supply. A CMOS inverter solution for achieving that involves setting a width to length ratio for the two transistors. For example, the width to length (W/L) ratio of a P-channel transistor can be made much larger than the W/L ratio of the N-channel transistor.

A small signal analysis of the inverter can be undertaken about the self-bias point, in which the input and output are coupled together without any other extra load. The first order of approximation of the MOS transistor's source-drain current in the saturated region is given by the equation:

Ids=(K*W/L)*(Vgs−Vt)² (1)

for Vds>(Vgs−Vt) (i.e., in saturation region), where
Vds=drain to source voltage,
Ids=drain to source current,
W=MOS transistor's channel width,
L=MOS transistor's channel length,
Vgs=applied gate to source voltage,
Vt=MOS transistor's threshold voltage,
K=constant determined by process variables

The P-channel MOS transistor 412 operates as a current source for providing current to the N-channel MOS transistor 414, which also operates as current source. The on-resistance of transistor 412 is very high and the current flowing across it is very low. Transistors 412 and 414 behave as a high-resistive voltage divider where the divide ratio is a function of their respective on-resistive values. Transistors 412 and 414 can be sized so that their interception point, i.e., node 413, will have a voltage level substantially equal to the half of the power supply voltage. In an embodiment, the dc bias circuit 350 is implemented using a MOS process. P-channel transistor 412 has a width of 0.5 micron and a length of 450 micron. And the current Ip 415 flowing across transistor 412 is less than 100 nA with the power supply of about 5.0V.

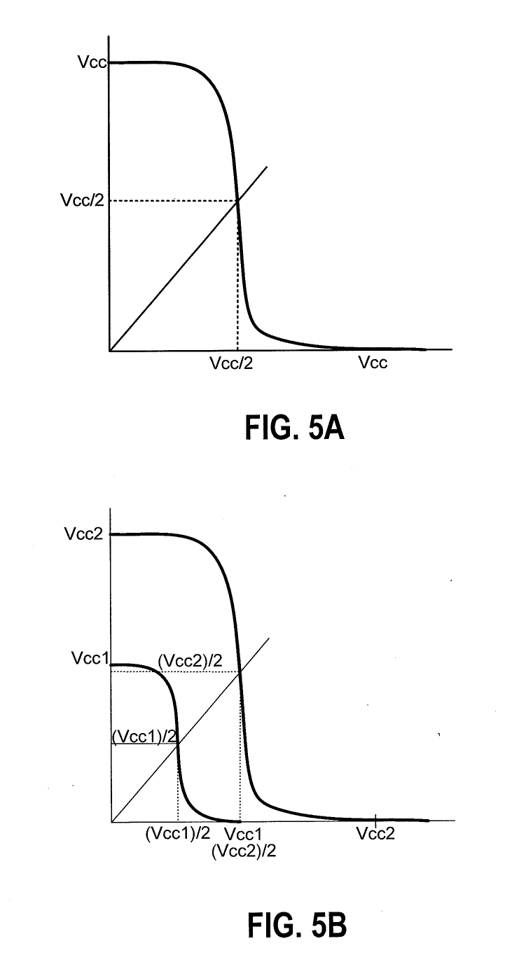

FIG. 5A shows an idealized voltage transfer characteristic curve of a CMOS inverter having a negative feedback according to an embodiment of the present invention. Under certain design rules, the inverter is biased about the mid-point in the linear segment on the steep transition of the voltage transfer characteristics.

FIG. 5B is a graph illustrating typical voltage characteristics at different values of the power supply. The shape of these transfer curves are relatively constant with temperature.

Buffer circuit 450 in FIG. 4 operates as a source follower. In an embodiment, buffer circuit 450 includes an N-channel MOS transistor 452 connected in series with a P-channel transistor 454. Transistor 452 has a resistance Ron that depends from the gate-source voltage Vgs 455. Gate-source voltage is determined by the following equation:

Vgs=Vin−Vout≈Vt (2)

where Vt is the threshold voltage of the N-channel MOS transistor 452. In an embodiment, MOS transistor 452 is a native N-channel MOS transistor having a threshold voltage substantially equal to 0V so that transistor 452 can deliver a large pull-up current.

The source of transistor 452 is further connected to a source of transistor 454 that represents a resistive load Rload. In an embodiment, the interconnection of transistor 452 and 454 is electrically connected to a bonding pad 453. Pad 453 has a voltage level that follows the voltage level Vref 413 at the input of buffer circuit 450. Reference voltage circuit 400 further includes a capacitor Cext 460 that is coupled to pad 453. In an embodiment, pad 453 is a bonding pad that constitutes the external connection terminal. Thus, capacitor Cext 460 is external to reference voltage circuit 400. Capacitor Cext 460 has a capacitance value that is adequate to maintain the voltage at pad 453 for a long period of time when the power supply source of reference voltage circuit 400 is switched off or disconnected. In order to rapidly charge capacitor Cext 460, it is preferable to obtain a sufficient large W/L ratio of N-channel MOS transistor 452.

If the power supply is switched off or disconnected, both transistors 452 and 454 will change to the off-state so that their impedance rapidly reach a very high value, i.e., buffer circuit 450 is in a high-impedance state. Capacitor Cext 460 thus keeps the stored voltage level for a time duration that is determined by the values of the Ron, Rload and Cext. As the value of Ron, Rload of transistors 452, 454, and Cext is very high, the discharge time of capacitor 460 is very long. Thus, the voltage reference Vref is maintained when the power supply is switched off or electrically disconnected from the audio driver. When the power supply is switched on again or electrically connected back to the audio driver, the reference voltage is already available to the audio driver without any significant delay so that the voltage difference between the speaker terminals is minimal and pops noise is suppressed. It is noted that the buffer circuit is in a high-impedance state if the voltage is about half the supply voltage, VDD. If the voltage deviates from half VDD due to, for example, too much by leakage or some external influence, the buffer circuit becomes very low impedance to bring the voltage back to half VDD. Thus, the buffer circuit is configured to maintain the voltage around half VDD.

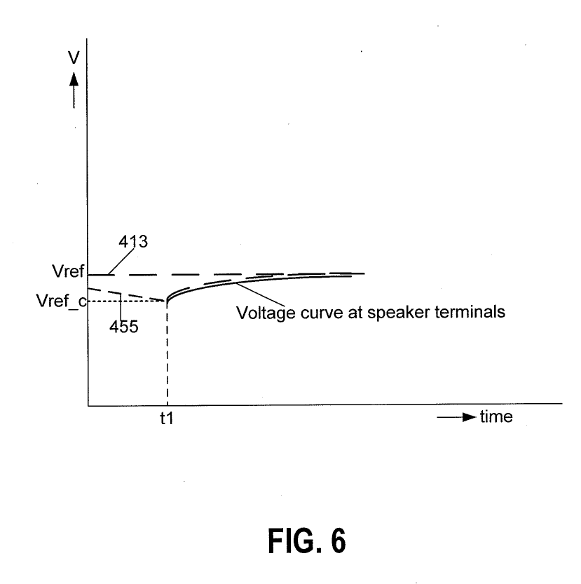

FIG. 6 is a graph illustrating the voltage waveform Vref c 455 at the external capacitor Cext 360 or 460. Voltage waveform 455 shows that capacitor 360 or 460 may not be ideal and has a certain leakage current so that the stored voltage value is decreasing with time when the power supply is disconnected. The leakage current may also caused by a non-ideal buffer circuit where native NMOS transistor 452 and PMOS transistor 454 (FIG. 4) do not have an infinite impedance when the power supply is turned off or electrically disconnected. The speaker terminals may be substantially equal voltage at power-up or if not, their difference is insignificant so that the speaker does not produce audible pops because internal amplifiers and nodes of the audio driver can reach their stable operation conditions much quicker due to the immediate availability of the common mode voltage source. In some embodiments, the startup time for the audio driver can be as short as 1 msec or less. Put another way, a proper bias voltage can be established within 1 msec or less after the circuit is powered up.

In an embodiment, PMOS transistor 412 of self-biased circuit 410 has been implemented with a channel width of 0.5 micron and a channel length of 450 micron; NMOS transistor 414 has been implemented with a channel width of 0.5 micron and a channel length of 900 micron. The standby current is less than 100 nA with a power supply of 5V.

The above described embodiments of the present invention not only provide pops suppression, but also allow a fast start-up operation. Although the embodiments are described for audio driver applications, they may be used for other applications where a fast start-up time is necessary or desired.

Many modifications may be made to the above described embodiments without departing from the scope of the invention as claimed below. For example, additional devices may be inserted between various nodes, terminals, and devices in the above embodiments without materially changing their overall function. For example, voltage drops may be introduced by diodes, or transistors configured as diodes, to change various voltage levels, or buffers may be inserted between various nodes, transistors, and devices.

1. A device for suppressing audible transients comprising:
an amplifier having a first input and a second input; and
a reference voltage circuit configured to generate a bias voltage level;
wherein the first input of the amplifier is coupled to an input audio signal,
wherein the second input of the amplifier is coupled to the bias voltage level,
wherein the reference voltage circuit is configured to maintain the bias voltage level in the event that the device is powered off.

2. The device of claim 1 wherein the reference voltage circuit comprises:
a CMOS circuit interposed between a power supply source and a power supply sink; and
a buffer circuit configured to charge a capacitor;
wherein a standby current flows across the CMOS circuit.

3. The device of claim 2 wherein the standby current is about or less than 100 nA.

4. The device of claim 2 wherein the CMOS circuit comprises:
a first PMOS transistor having a first terminal coupled to the power supply source, a second terminal, and a third terminal, the second and third terminals being electrically connected together; and
a first NMOS transistor having a fourth terminal, a fifth terminal, and a sixth terminal; the fourth and fifth terminals being electrically connected to the second and third terminals of the PMOS transistor, and the sixth terminal being coupled to the power supply sink,
wherein the electrical connection of the second, third, forth, and fifth terminals of the first PMOS and NMOS transistors are configured to generate the bias voltage level.

5. The device of claim 2 wherein the buffer circuit comprises:
a second NMOS transistor having a seventh terminal coupled to the power supply source, an eighth terminal, and a ninth terminal coupled with the capacitor; and
a second PMOS transistor having a tenth terminal coupled to the ninth terminal of the second NMOS transistor, an eleventh terminal coupled to the eighth terminal of the second NMOS transistor, and a twelfth terminal coupled to the power supply sink.

6. The device of claim 2 wherein the CMOS circuit is configured to have a bias current of about 100 nA or less, when the bias voltage level is at about a mid point between the power supply source and the power supply sink.

7. The device of claim 2 wherein the capacitor is configured to store and maintain the common mode voltage when the power supply source is shut off.

8. The device of claim 2 wherein the buffer circuit is in a high-impedance state when the power supply source is shut off or disconnected.

9. The device of claim 1 wherein the reference voltage circuit is configured to generate the bias voltage level in 1 msec or less after power up.

10. A voltage reference circuit comprising:
a bias circuit for generating a reference voltage, the bias circuit including a CMOS circuit having device geometries selected for reducing off-state leakage current;
a capacitor for maintaining the reference voltage; and
a buffer circuit for charging the capacitor, the buffer circuit including:
an N-channel transistor having a substantially zero threshold voltage, the N-channel transistor including a first drain coupled to a power supply source, a first gate coupled to the reference voltage, and a first source coupled to the capacitor; and
a P-channel transistor having a second source coupled to the capacitor, a second drain coupled to a ground potential, and a second gate coupled to the reference voltage.

11. The voltage reference circuit of claim 10 wherein the buffer circuit is in a high-impedance state when the power supply source is shut off or disconnected.

12. The voltage reference circuit of claim 10 wherein the buffer circuit comprises a CMOS source follower circuit.

13. The voltage reference circuit of claim 10 wherein the reference voltage level is established in 1 msec or less after power up.

14. The voltage reference circuit of claim 10 wherein the bias circuit comprises:
a CMOS inverter coupled between the power supply source and the ground potential, the CMOS inverter having an input and an output electrically coupled together.

15. The voltage reference circuit of claim 10 wherein the reference voltage is about at a mid-point between the power supply source and the ground potential.

16. A method of suppressing audible transients generated from an amplifier, comprising:
providing a capacitor;
generating a reference voltage using a self-biased circuit; and
charging the capacitor with the reference voltage using a buffer circuit;
wherein the buffer circuit is configured to maintain the reference voltage at about a mid-point of a power supply.

17. The method of claim 16 wherein the self-biased circuit comprises a CMOS inverter having an input and an output, wherein the output is coupled to the input.

18. The method of claim 16 wherein the buffer circuit comprises:
a NMOS transistor having a first input and a first output; and
a PMOS transistor having a second input and a second output, the PMOS transistor being coupled to the NMOS transistor in series and being disposed between the power supply and a ground,
wherein the first and second inputs are coupled to the reference voltage;
wherein the first and second outputs are coupled to the capacitor.

19. The method of claim 16 further comprising:
maintaining the reference voltage by setting the buffer circuit in a high-impedance state during a power-down mode.

20. The method of claim 16 further comprising:
applying the reference voltage as a common mode voltage to the amplifier.
